(19) United States
(12) Patent Application Publication
(10) Pub. No.: US 2002/0003827 A1
(43) Pub. Date: Jan. 10, 2002

(54) Stop band laser apparatus and method

(76) Inventors: Azriel Zelig Genack, New York, NY (US); Victor Il?apos;ich Kopp, Flushing, NY (US)

Correspondence Address: Edward Etkin, Esq., Suite 3C, 4804 Bedford Avenue, Brooklyn, NY, 11235, US

(21) Appl. No.: 09/919,662

(22) Filed: Aug. 1, 2001

Related U.S. Application Data
(63) Continuation-in-part of application No. 09/302,630, filed on Apr. 30, 1999, now abandoned.
(60) Provisional application No. 60/083,973, filed on May 1, 1998.

(51) Int. Cl. H01S 3/20

(52) U.S. Cl. 372/51

(57) ABSTRACT

Band gap lasers based upon activated periodic one-dimensional structures are disclosed. The periodic structures may be cholesteric liquid crystals, other chiral materials, or materials with alternating dielectric layers with different indices of refraction. The amplifying component may be an organic dye, rare earth or other ion, conjugated polymer, or other luminescent materials. Lasing occurs at a predetermined frequency corresponding to that of modes at the edge of the stop band in these periodic structures or to the frequency of a defect mode introduced into the structure. The lasing threshold may be lowered and the efficiency raised by the following further considerations: Adjacent layers of different period, and correspondingly different stop band, are incorporated into the structure to serve as reflectors on either or both sides of the active medium. The peak emission of the active medium is chosen to be close to the frequency of one of the long-lived photon modes of the system.

### RELATED APPLICATIONS

This application is a continuation-in-part of the commonly assigned co-pending U.S. patent application Ser. No. 09/302,630 entitled “Stop-Band Laser” which was filed on Apr. 30, 1999, which in turn claims priority from the U.S. Provisional Application No. 60/083,973 entitled “Stop Band Edge Laser Based on Activated Periodic One-dimensional Dielectric Structures” which was filed on May 1, 1998.

### FIELD OF THE INVENTION

The present invention relates generally to the use of activated cholesteric and chiral liquid crystals in lasing applications, and more particularly to the utilization of periodic dielectric media as lasers based upon a photonic stop band in these structures.

### BACKGROUND OF THE INVENTION

Semiconductor lasers have found many industrial and commercial applications in recent years. For example lasers are used in telecommunications, in optically readable media pickups that are used in CD players, CD ROM drives and DVD players, in medical imaging, and in video displays. However, previously known semiconductor lasers have a number of disadvantages. For example, traditional semiconductor lasers, such as ones used in CD players, emit light from the edge of a chip, so it is necessary to cleave a wafer into chips and package the chip before knowing if the laser functions properly. Other types of light sources, such as LEDs do not provide the performance needed for certain applications. In recent years, new types of band gap lasers that provide a number of advantages over traditional semiconductor lasers have been developed and discussed in scientific literature.

In order to better understand the technology of band gap lasers it would be helpful to provide an overview of their scientific principles. In analogy with the gap in the density of electronic states in semiconductors, a gap in the density of electromagnetic modes or photon states may exist in certain dielectric structures. Within this gap, the intensity of incident electromagnetic radiation in any direction is evanescent, falling exponentially within the medium. Such a photonic band gap may be produced in a three-dimensional periodic structure with sufficient contrast in the index of refraction within the medium.

When propagation is forbidden over a certain frequency range, and only occurs in a specific direction or in a limited range of directions, the material is said to possess a stop band rather than a full photonic band gap. Periodic one-dimensional structures posses numerous stop bands, but since they only allow propagation parallel to the layers, they do not possess a full photonic stop band. When a defect is placed in an otherwise periodic three-dimensional structure possessing a photonic band gap, a long-lived spatially localized defect state can be created with a frequency within the photonic band gap.

Three-dimensional photonic band gaps have been observed in dielectric materials with sufficiently high modulation of the refractive index, but manufacturing such materials with known micro-fabrication techniques is very difficult. Lasing has been observed in periodic one-dimensional semiconducting structures possessing a defect. These systems known as vertical cavity surface emitting lasers (VCSELs) are arranged as posts with high aspect ratio. Emission is the result of the recombination of electrons and holes in a semiconductor layer at the center of the structure. The defect in the structure results in an extended photon dwell time within the medium. This facilitates lasing because it increases the probability that a photon will stimulate emission from the excited state of another photon before it escapes from the structure.

However, VCSELs suffer from a number of disadvantages. The manufacture of VCSELs requires sophisticated and expensive micro-fabrication. Since single-pass gain in thin layer semiconductor lasers is low, VCSELs incorporate highly reflective dielectric stacks which are integrated into the laser as Bragg reflectors. These consist of alternating layers of dielectric material, which are grown using methods of molecular beam epitaxy (MBE). This ensures a close match of the atomic lattice structures of adjacent layers. Alternating atomically ordered layers of materials with different electronic characteristics are thereby produced. The interfaces between the layers must be digitally graded and doped to reduce the electrical resistance.

Much work has been done to improve the performance of VCSELs by increasing the number of layers and/or the dielectric difference between alternating layers. However, this approach makes the fabrication more expensive and difficult. There is also a limit to the number of layers determined by absorption in these layers. While VCSELs can be manufactured in two-dimensional arrays, there has been great difficulty in achieving uniform structure over large areas and in producing large area arrays. The materials typically used for VCSELs do not have the desired low absorption and high index contrast over a broad frequency range. In particular, it is difficult to achieve high reflectivity in the communication band around 1.5 microns.

In addition, VCSELs cannot be tuned in frequency since their periods cannot be changed. The density of photon modes is not changed appreciably by use of a low index contrast multi-layer Bragg reflector as compared to that in an ordinary laser cavity. Also, an external device must be used to control the polarization of light.

The previously known lasing techniques in periodic structures possessing a photonic band gap generally depend on stimulated emission from a defect state introduced into the material, with a frequency which falls within the photonic band gap or stop band. Lasing in a defect free periodic one-dimensional structure of alternating dielectric layers with different refractive indices is also known. The prior art technologies depend on the concept of the group velocity derived from a dispersion relation which relates the frequency and wave vector of propagation in an infinite medium. For an infinite medium the group velocity is predicted to tend to zero for states approaching the edge of the stop band. This view does not consider the key element that lasing occurs at specific modes of a finite medium and that for modes near the band edge, the dwell time of photons in the medium is long and the spectral width of the corresponding modes are narrow. The previously known views of lasing in defect-free, one-dimensional systems also do not include the effect of rapidly decreasing photon dwell time as the mode is spectrally removed from the stop band, which is essential to understanding the spectral characteristics of lasing and to optimizing laser performance.

It would thus be desirable to provide a band gap laser with increased output power and low lasing threshold. It would further be desirable to provide a band gap laser with improved control over the spatial, spectral, and temporal lasing parameters thereof.

### SUMMARY OF THE INVENTION

This invention relates to use of periodic structures combined with an excitable light-emitting material to produce lasing. The modification of the photon density of states in a periodic one-dimensional structure transforms its emission and propagation properties and serves as the basis for the presently disclosed embodiments of inventive efficient microscopic lasers that emit radiation at the edge of their photonic stop band. The inventive laser can be produced even without introducing a defect into the structure—this approach is in stark contrast to previously known scientific literature relating to periodic lasing in two and three-dimensional periodic structures that outlined requirements for a defect in the structures in order for lasing to occur. In addition, the inventive laser having controlled properties selected as a matter of design choice can be advantageously produced using self-organized chiral materials, and in particular cholesteric liquid crystals. The reflection band in these chiral materials can be treated as photonic stop band and consequently these materials, when appropriately activated, exhibit lasing at the long lived photonic states closest to an edge of the stop band.

Even though lasing on the inventive structure occurs without a defect, defect states with enhanced photon dwell times states can be introduced into the photonic stop band of the structure, resulting in lasing at the frequency of these defect modes in activated samples. When a defect is placed in an otherwise periodic three-dimensional structure possessing a photonic band gap, a long-lived spatially localized defect state can be created with a frequency within the photonic band gap. A defect may be created by adding or removing high or low index material at a site within the structure or by spatially displacing part of the structure. The lifetime of the excited state of the defect in the medium can be significantly lengthened and the fraction of emission into the defect mode can be enhanced if the spectrum of the active medium lies substantially within the photonic band gap. This is because the primary de-excitation mechanism in high quality lasing materials is spontaneous emission, which is suppressed at frequencies within the band gap, other than at the frequency of the defect mode. The suppression occurs because the rate of spontaneous emission is proportional to the density of photon states, which vanishes throughout the photonic band gap apart from the narrow spectral region encompassing the defect mode. As a result, emitted photons are efficiently utilized to produce laser radiation at the defect mode and the lasing threshold may in principle be lowered.

The inventive lasers are constructed from one or several juxtaposed one-dimensional stop-band materials. These stop-band layers can be alternating thin layers with different dielectric constant or a cholesteric liquid crystal or chiral material, or other materials with similar properties known in the art. However, it is essential that one or more of these layers must be optically or electronically active (i.e. it must be an emitting material) such that when the emitting material is excited, a gain region is produced therein. This gain region, which may or may not have a defect as a matter of design choice, may be disposed adjacent to a single stop-band reflector, between two stop-band reflectors, or within the stop band material. A gain source such as an optical pump or electrical source excites the active material to form the gain region therein. The stop-band reflectors have a period such that the emission frequency falls within the stop band of these materials or overlaps one of their edges. The reflectivity of these layers is determined by the period, thickness and composition of each layer. The resulting integrated device has controlled output coupling for laser radiation.

It is the essence of the present invention that the most efficient laser is produced when the peak of the emission spectrum of the emitting material lies near that of the mode of the inventive periodic structure with the narrowest width and consequently longest photon dwell time. This near coincidence of the peak of the long-lived modes of the medium and of the emission peak of the active medium determines the frequency of the laser. Thus maximum efficiency lasing occurs when the peak of the emission spectrum lies near one of the band edges or the defect state (if a defect is present in the structure). Lasing efficiency may be further enhanced by adjustment of the reflectivity of layers adjacent to the gain region.

The modulation of the molecular structure on a length scale of the optical wavelength in pure cholesteric liquid crystal media and in such media doped with dye molecules or other amplifying species results in dramatic modifications of their optical propagation characteristics and photon density of states. Circularly polarized light propagating perpendicular to the planes of the structure is strongly reflected when the optical polarization matches the sense of rotation of the molecules within the cholesteric liquid crystal. The reflection band extends over a range of wavelengths of width Δλ=λ₀(Δn/nₐᵥ) centered at a wavelength in the medium given by λₙ=λ₀/nₐᵥ=P, where P is the pitch of the rotating structure of the optically active molecules. Here, nₐᵥ=(n₀+nₑ)/2 is the average refractive index and Δn=(n₀−nₑ) is the optical birefringence of the medium. The pitch is the longitudinal distance in which the molecular orientation associated with each plane of the sample undergoes a complete rotation. The reflection induced by the periodic modulation of the refractive index leads to strong distributed feedback which is peaked at a wavelength equal to P.

Although producing three-dimensional photonic band gaps at optical frequencies remains a challenge, one-dimensional materials possessing a stop band can be readily produced. The density of states of modes propagating in the longitudinal direction is suppressed within the stop band in which the incident radiation is strongly reflected. Even though this may not dramatically alter the entire three-dimensional density of states, the inventive approach radically changes the lasing properties of the medium.

The rate of spontaneous emission in any direction is proportional to the density of states in that particular direction. If the density of states is suppressed in a particular direction, emission into that direction in inhibited. Thus, though the peak reflectivity of a particular handed circular polarization in the direction perpendicular to the planes of the cholesteric liquid crystal material occurs at the center of the reflection band, emission does not occur at this wavelength. Rather emission and lasing occur at the high and low frequency edges of the reflection band and not in the middle of the reflection band, where the density of states in the direction perpendicular to the layers is zero. It is the modes at the edge of the band which have the longest photon dwell time in the medium. This facilitates lasing in activated media because the likelihood that emitted photons will stimulate further photon emission before leaving the gain medium is thereby enhanced.

Thus in one embodiment of the present invention, lasing with right circularly polarized (RCP) light propagating perpendicular to the molecular planes is produced at the edge of a reflection band from a right-handed dye-doped cholesteric liquid crystal structure. The propagation of left circularly polarized (LCP) light is unaffected by the structure and leads to a dye emission spectrum similar to that for molecules within a homogenous host. Since the density of states for LCP light in a right-handed structure has a constant value, the ratio of the emission of RCP and LCP light is proportional to the density of states of the RCP light. This ratio shows a distinct gap within the reflection band and an enhancement at the band edge. Similar results are achieved for left circularly polarized light in a left-handed dye-doped cholesteric liquid crystal structure.

Since the photon dwell time is dramatically lengthened for the mode closest to the band edge and decreases rapidly for modes shifted away from the band edge, lasing in such periodic structures is confined to one or a few modes near the band edge. At the lowest powers, lasing occurs only at the mode closest to the band edge but lasing radiation is produced in additional modes at higher powers. Lasing excited by a focused pump laser with a frequency above the stop band occurs in a narrow cone normal to the periodic planes.

In another embodiment of the present invention, a planar laser is achieved by exciting an activated chiral medium along a line in the plane, when the excitation is produced along this line is at a frequency near the band edge for radiation propagating perpendicular to the planes.

In yet another embodiment of the present invention, a defect laser is produced by placing a defect in the periodic structure. For example, a displacement between two sections of a cholesteric liquid crystal introduces a long-lived defect state in the stop band. Lasing from the defect state is also enhanced by adjusting the frequency of the state to coincide with the frequency of peak emission of the activated material.

One of the advantages of the inventive apparatus is that it provides for high conversion efficiency, low threshold lasing based on the existence of the stop band. The distinction between the frequency at the center of the reflection band of the activated medium, the associated band edges, the peak of the emission spectrum of the amplifying medium, the defect frequency, and the center and edge frequencies of stop band materials adjoining the active medium, makes it possible to design and optimize the characteristics of the laser. These characteristics include the laser frequency and the lasing threshold and conversion efficiency. The inventive apparatus makes possible mirror-less narrow line-width microscopic lasers, with thickness as small as an order of magnitude larger than P. The laser emission is circularly polarized, according to whether the structure is a right or left handed.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein like reference characters denote like elements throughout the several views:

FIG. 1 is a schematic diagram of the periodic structure of a cholesteric liquid crystal;

FIG. 2 is an schematic diagram of a layered dielectric structure with field and intensity distributions near the center of the material at the high and low frequency band edges;

FIG. 3 is a diagram of a dispersion relation and photonic band structure of a cholesteric liquid crystal;

FIG. 4 is a diagram of a photonic band structure of a layered dielectric material;

FIG. 5 is a diagram of an energy density of the electromagnetic field inside a one-dimensional layered dielectric structure at the wavelength of the first mode;

FIG. 6 is a diagram of an energy density of the electromagnetic field inside a one-dimensional cholesteric liquid crystal structure at the wavelength of the first mode;

FIG. 7 is a diagram of a transmittance of a one-dimensional layered dielectric structure and a cholesteric liquid crystal structure;

FIG. 8 is a diagram of a transmittance of a one-dimensional layered dielectric structure and a cholesteric liquid crystal structure;

FIG. 9 is a schematic diagram of a dye-jet laser and of a dye-doped cholesteric liquid crystal laser;

FIG. 10 is a diagram of an emission spectrum from a cholesteric liquid crystal structure at various lasing power settings;

FIG. 11 is a diagram of relative intensities of emission from various modes at different laser powers;

FIG. 12 is a diagram of a spectrum of left and right circular polarized emission from a left handed cholesteric liquid crystal;

FIG. 13 is a diagram of a ratio of intensity of right circular polarized emission to that of left circular polarized emission as well as the reflectance from a dye-doped cholesteric liquid crystal;

FIG. 14 is a diagram of an emission spectrum of an amplifying medium peaked near the stop-band edge;

FIG. 15 is a schematic diagram of a first embodiment of a stop band edge cholesteric liquid crystal laser;

FIG. 16 is a schematic diagram of a second embodiment of a stop band edge cholesteric liquid crystal laser;

FIG. 17 is a schematic diagram of a third embodiment of a defect state cholesteric liquid crystal laser;

FIG. 18 is a schematic diagram of a fourth embodiment of a defect state cholesteric liquid crystal laser;

FIG. 19 is a schematic diagram of a fifth embodiment of a defect state cholesteric liquid crystal laser;

FIG. 20 is a schematic diagram of a defect state cholesteric liquid crystal laser; and

FIG. 21 is a schematic diagram of a cholesteric liquid crystal planar waveguide.

### DETAILED DESCRIPTION OF PREFERRED EMBODIMENTS

The present invention is described with reference to cholesteric liquid crystal materials by way of example only—it should be understood that the apparatus and method of the present invention may be utilized with any chiral material having properties similar to cholesteric liquid crystals, without departing from the spirit of the invention. Before describing the present invention in greater detail, it would be helpful to provide a brief description of the dielectric lasing materials and terminology. Liquid crystals are fluids that have relatively long, cylindrical molecules. These molecules can arrange themselves in a structure in which the molecular direction has some degree of periodicity. Cholesteric liquid crystals have the symmetry of either a right or left-handed screw. Cholesteric liquid crystal molecules arrange themselves in approximately parallel layers each a few angstroms thick. The axes of the molecular director lie in the plane and rotate from plane to plane forming the helical structure with pitch P. Cholesteric liquid crystals strongly reflect normally incident, circularly polarized light with the same sign of rotation as the cholesteric liquid crystal structure

The reflection band extends over a range of wavelengths of width, Δλ=λ₀(Δn/nₐᵥ) centered at a wavelength in the medium given by, λₙ=λ₀/nₐᵥ=P, where P is the pitch of the rotating structure of the optically active molecules. Here, nₐᵥ=(n₀+nₑ)/2 is the average refractive index and Δn=(n₀−nₑ) is the optical birefringence of the medium. The pitch is the longitudinal distance in which the molecular orientation associated with each plane of the sample undergoes a complete rotation. The reflection induced by the periodic modulation of the refractive index leads to strong distributed feedback which is peaked at a wavelength equal to P. Light with the opposite sign of rotation as the structure is not reflected.

The reflection band in cholesteric liquid crystals has not previously been associated with the photonic band gap or stop gap behavior. Prior art teaching of emission within such a structure did not recognize the suppression of states within the stop band or the special properties of modes at the edge of the stop band. For example, a dye-doped cholesteric liquid crystal medium was previously described as having internal distributed feedback resulting from its chirality. This configuration was described as allowing several modes close to the frequency of peak reflection to oscillate at once due to their similar lasing thresholds. Consequently, the structure was presumed to produce lasing over a band of frequencies within the reflection. When lasing was observed at a frequency significantly displaced from the center of the reflection band, it was explained as the result of inhomogeneity in the pitch of the sample.

The prior art requires the addition of a spectral filter and mirror external to the cholesteric medium in order to achieve narrow band lasing. These elements of laser design, which are essential parts of ordinary dye lasers, are advantageously eliminated in the present invention. Instead, the photonic band structure itself serves to produce spectrally selective enhancement of the photon dwell time in the medium. The resulting microscopic, narrow-band laser is consequently automatically aligned and optimized.

The feedback of light in the apparatus of the present invention is distributed throughout the medium rather than being achieved with discrete elements such as external mirrors. A branch of laser theory has previously considered lasing in distributed feedback structures. But it was generally assumed that the modulation of the structure was weak, resulting in a slight shifting of the laser mode frequencies rather than the creation of a gap. In such traditional distributed feedback lasers, lasing occurs near the Bragg frequency, which is not appreciably shifted from adjacent modes. Because the structure of these lasers is not strongly modulated, the density of states is only weakly affected and the laser cannot achieve the microscopic size and low thresholds possible in the present invention.

In summary, the reason why the inventive apparatus enables high efficiency low threshold lasing significantly superior to previously known techniques is that the peak of an emission spectrum of an emitting material of the inventive apparatus lies near that of the mode of the periodic structure having the narrowest width and consequently longest photon dwell time. This near coincidence of the peak of the long-lived modes of the medium and of the emission peak of the active medium produces low threshold lasing at a frequency determined by the modes of the structure and, in particular, the mode closest to the band edge or a defect mode (if a defect is present in the structure).

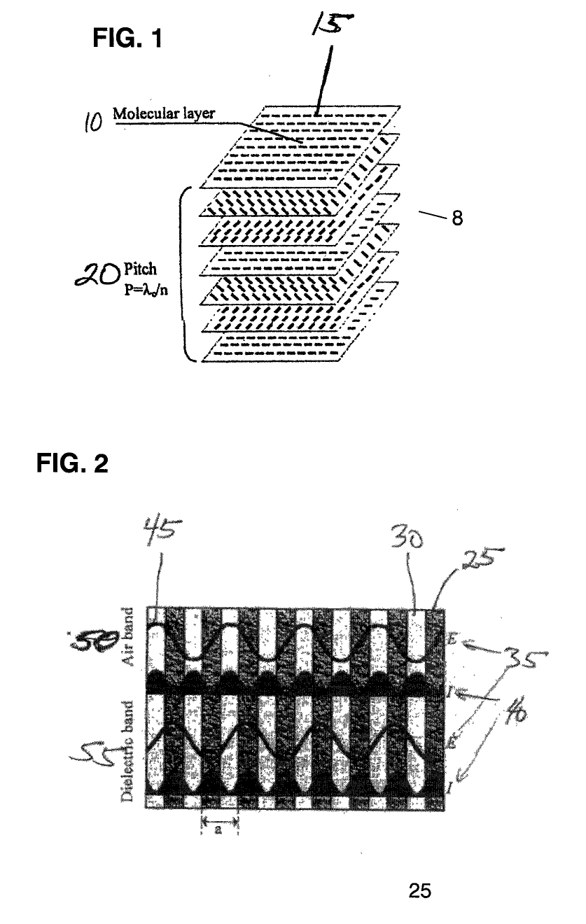

Referring now to FIG. 1, the general molecular structure of a right-handed cholesteric liquid crystal is shown. A cholesteric liquid crystal has a plurality of layers 10, each with molecules 15 having an average orientation in a direction called the director. A cholesteric liquid crystal has the symmetry of a left or right-handed screw. The director rotates at a certain angle in each molecular layer giving a rotation of 360° in a length equal to the pitch P 20. The wavelength in the medium at the center of the reflection band is equal to P.

Referring now to FIG. 2, an inventive layered dielectric structure 8 is shown. Dark 25 and light 30 layers correspond to high and low refractive indices, respectively. Electric field 35 and intensity 40 near the center of the sample are shown. The intensity 45 of the standing wave component of light at the high frequency band edge has maxima in the low index layers and nodes in the high index layers. This leads to a concentration of energy in regions with low refractive index. Since the energy is concentrated in the low index part of the sample the frequency region is referred to as the air band 50. The opposite situation, in which the nodes fall within the low index layer while maxima coincide with the high index layers prevails at the low frequency edge. This leads to a concentration of energy in the region with high refractive index, and this spectral range is called the dielectric band 55.

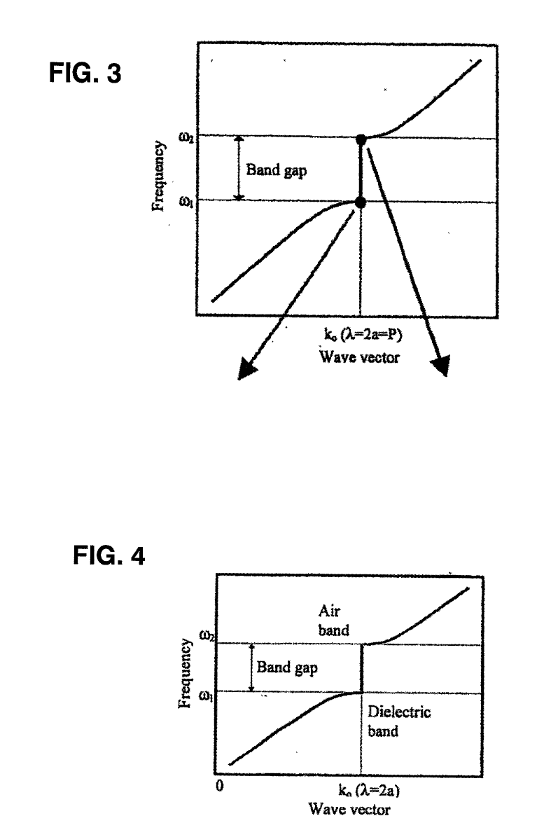

Referring now to FIG. 3, a dispersion curve for a photonic band of a cholesteric liquid crystal structure with a period a and pitch P=2a is shown. The direction of the electric field of the standing circularly polarized wave, with the same sign of rotation as the cholesteric liquid crystal structure itself, rotates in space with pitch P since the electric field is parallel (perpendicular) to the molecular director at the low (high) frequency edge of the stop band and the field experiences only an index of nₑ (n₀).

Referring now to FIG. 4, a dispersion curve for a photonic band of a layered dielectric structure with period a is shown.

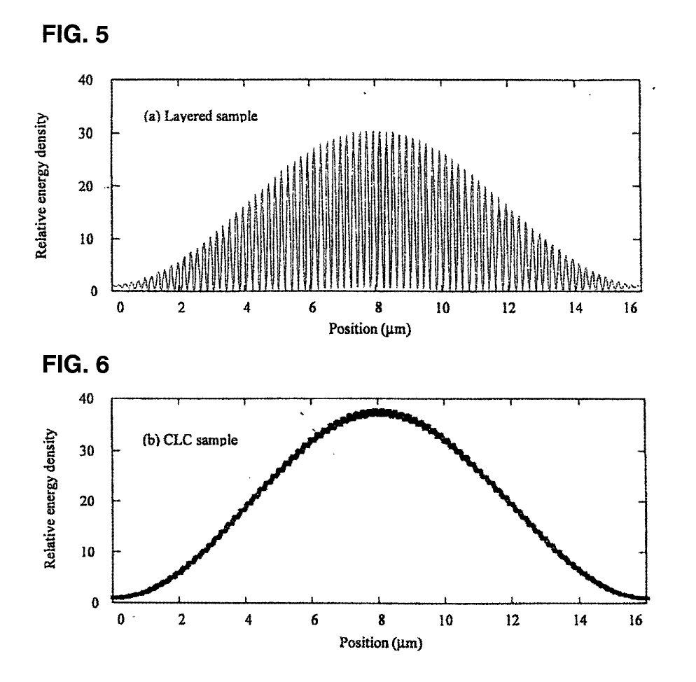

Referring now to FIGS. 5 and 6, a distribution of the energy density of the electromagnetic field inside a one-dimensional periodic structure at the wavelength of the first mode is shown. The refractive indices are 1.47 and 1.63 for the layers of a layered dielectric structure and for the ordinary and extraordinary indices of a cholesteric liquid crystal. In the layered dielectric material, the indices correspond to those of the two layers of equal thickness, whereas they correspond to ordinary and extraordinary indices in cholesteric liquid crystals. The intensity inside the layered dielectric structure is modulated on the scale of the wavelength, where the intensity in the cholesteric liquid crystal has a slow modulation. The electric field in this standing circularly polarized wave oscillates in time in the cholesteric system, but unlike a traveling circularly polarized wave, the direction of the field does not oscillate. For higher order modes the intensity envelope is modulated with a number of peaks equal to the mode number designating modes further removed from the band edge.

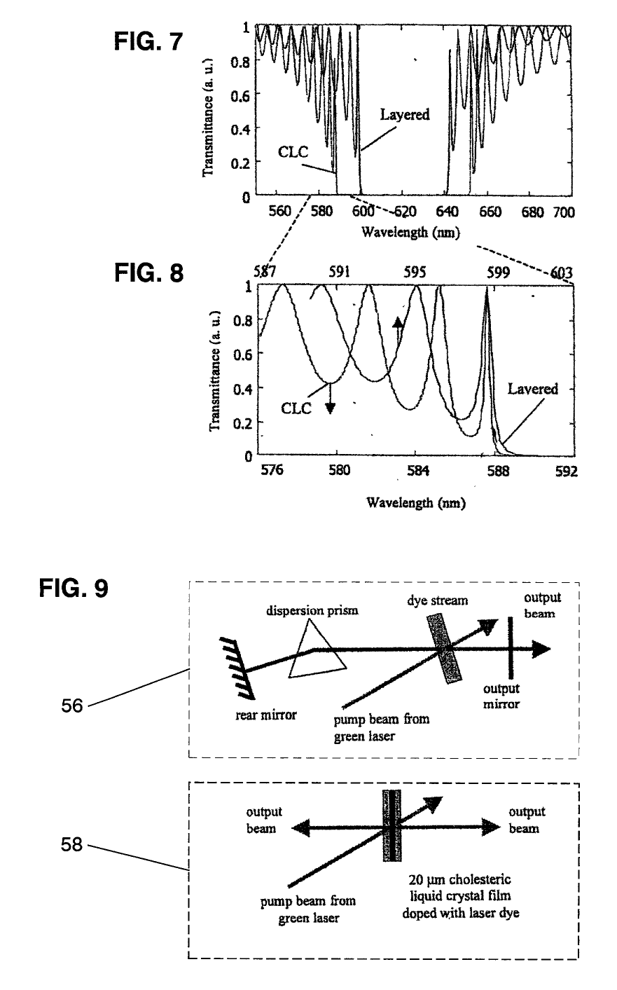

Referring now to FIG. 7, transmittance spectra computed by computer simulation for layered and cholesteric liquid crystal structures with the same parameters as in FIGS. 5 and 6 are shown. Spectra are shown for circularly polarized light for the cholesteric liquid crystal and for linearly polarized light for the layered structure. For the same index contrast, period and total thickness, the modes at the band edge for the cholesteric liquid crystal structure are narrower and more closely spaced than for the layered dielectric material. This indicates that for a fixed sample thickness, the cholesteric liquid crystal structure has a higher density of photon states near the band edge and that the level widths of these states is narrower than in the layered dielectric structure. This corresponds to an enhanced photon residence time within the sample at the frequency of these modes. The modification of the density of states in these materials directly affects the intensity of both spontaneous and stimulated emission at a given frequency which are proportional to the density of photon states. This is similarly reflected in the narrowing of modes at the band edge, which reflects the lengthened photon dwell time. This enhances the amplification of photons of that frequency inside the medium.

Referring now to FIG. 8, transmittance at the band edge of layered and cholesteric liquid crystal structure with the same parameters as in FIGS. 5 and 6 is shown. The spectra are referenced to the band edge to facilitate a comparison of the mode characteristics of these systems.

Referring now to FIG. 9, a comparison between a prior art dye-jet laser 56 and an inventive dye-doped cholesteric liquid crystal laser 58 is shown. The dye-jet laser 58 utilizes a flowing dye stream, frequency selective elements to narrow the laser output spectrum, and two mirrors. These elements must be carefully adjusted to achieve lasing and to optimize the laser characteristics. In contrast, the cholesteric liquid crystal laser is an integrated structure requiring no adjustment. Thus, the inventive CLC laser 58 requires significantly less components than the previously known laser 56 and has a much simpler construction and operation.

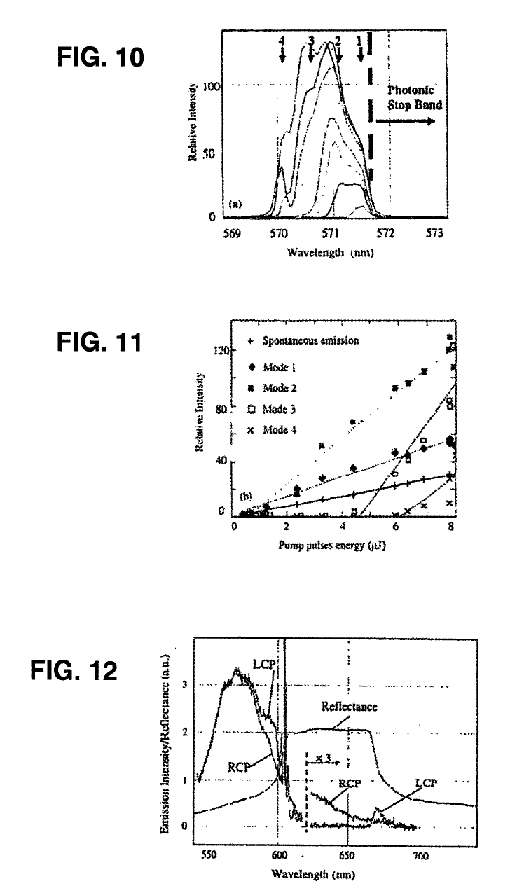

Referring to FIGS. 10-13, exemplary results of various experiments on two inventive cholesteric liquid crystal samples with different host compositions are shown. It should be noted that all parameters and substances used in the experiments are described by way of example only and shall not serve as a limitation on the present invention. Each of these samples was doped with laser dye PM-597 (1, 3, 5, 7, 8-pentamethyl-2, 6, -di-t-butylpyrromethene-difluoreborate complex). This gave rise to an absorption peak at 530 nm and an emission peak near 570 nm. Samples 1 and 2 had right and left-handed helical structures, respectively. Emission in these samples was studied by use of the second harmonic of a Q-switched Nd:YAG laser with and without mode locking. Individual mode-locked pulses were approximately 70 ps long. Single Q-switched pulses were 150 ns long with maximum pulse energy of 1 mJ. The energy of the pump laser pulse was controlled by use of an electro-optic attenuator. The pump beam was approximately 5 mm in diameter at the focusing lens, which resulted in spot diameters of approximately 40 and 20 microns for the 30 and 14-cm focal-length lenses, respectively. A lens with a focal length of 5.5 cm was used to collect the emitted light and to focus it onto the entrance slit of the spectrometer; this corresponds to a collection angle of 30° in air and 18° within the cholesteric liquid crystal film. The emission was dispersed in a spectrometer and recorded with a CCD detector that captured a 74-nm band with a resolution of 0.075 nm.

RCP laser emission spectra from sample 1 at different pump powers are shown in FIG. 10 for Q-switched pump pulses. At low pump power a single laser line with a width of approximately 0.2 nm was observed at the stop band edge at 571.5 nm. Even at high pump power values, only a small number of closely spaced modes within a total width of ˜1 nm are involved in lasing. The center of the laser emission at higher powers shifted from the band edge to wavelengths at which the utilization of the excitation within the medium is improved. The energy-conversion efficiency from the pump to the laser beam was as high as 25% at a pump pulse energy of 0.1 mJ. The spacing between modes shown in FIG. 10 is considerably less than the mode spacing of δλ˜λ_{c}²/2Ln=5 nm for a 20 μm-thick film, which is consistent with the increased density of states expected at the edge of the stop band.

The dependence of the output energy on pump power for modes near the band edge for sample 1 is shown in FIG. 11. For comparison, the linear dependence of the spontaneous emission integrated over the spectrum from 547 to 622 nm is also shown. Mode 1 at 571.5 nm, which is closest to the band edge, has the lowest lasing threshold. Lasing was observed at the lowest pump energies at which reliable spectral measurements are possible of 0.3 J. The thresholds for modes 2, 3 and 4, which peaked near 571.1, 570.5, and 570.2 nm, respectively, can be seen to increase with increasing frequency shift from the band edge. The rate of increase of output power can be seen in FIG. 11 to increase with mode number to mode 3.

In sample 2, which has a stop band that is shifted away from the emission peak, lasing is observed only when the pump laser is both mode-locked and Q-switched. Polarized emission spectra from this sample are shown in FIG. 12. For reference purposes the unpolarized reflectance spectrum is also presented. LCP lasing again occurs at the blue edge of the reflection band, which is the closest edge to the emission peak. The peak intensity of the laser lines is 100 times greater than the maximum of the spontaneous emission. The RCP emission spectrum has a single broad peak and is similar to the emission spectrum that is expected from molecules within an isotropic host. However, LCP emission is suppressed in the stop band and enhanced above the level of RCP emission at both edges of the band.

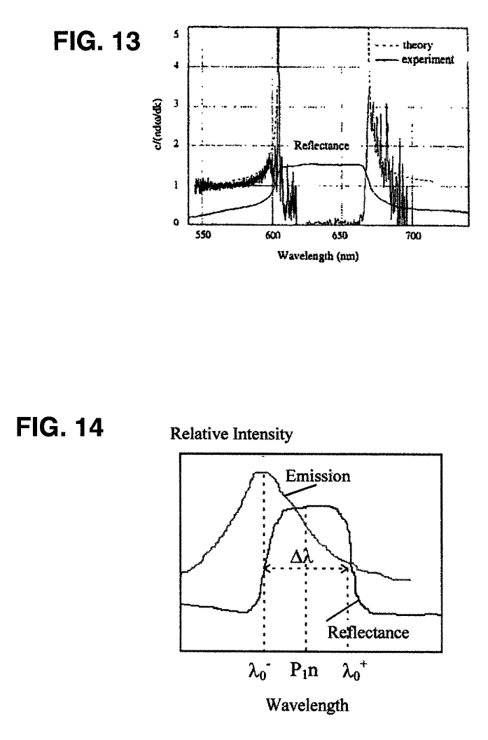

Both LCP and RCP spontaneous emission are emitted by the same dye in the same host and the periodic structure does not influence the dipole matrix element. Since the RCP spectrum is uniform, the ratio of LCP to RCP spontaneous emission, which is shown in FIG. 13, is proportional to the density of photon states. Further, since the density of states for the light with the opposite sign of circular polarization as the chirality of the cholesteric liquid crystal is constant with the frequency, the ratio is proportional to the density of states of the light with the same sign of circular rotation as the chirality of the structure. In one-dimensional structures the density of states is proportional to 1/(dω/dκ), where ω and κ are the frequency and the wave vector of light, respectively. The density of states diverges at the band edge of infinite one-dimensional structures, in contrast to the density of states in two and three-dimensional structures, which vanishes at the band edge. FIG. 13 shows agreement between the ratio of LCP and RCP spontaneous emission and (c/n)/(dω/dκ), where c is the velocity of light in vacuum:

nₐᵥω(κ)/c=sign(κ−κ₀)(κ²−2κκ₀+κ₀²)^{½}+ω₀,

ω₀=2πnc/λc,Δω=ω₀Δn/nₐᵥ, and κ₀c/nₐᵥ=[ω₀²−(Δω/2)²]^{½}.

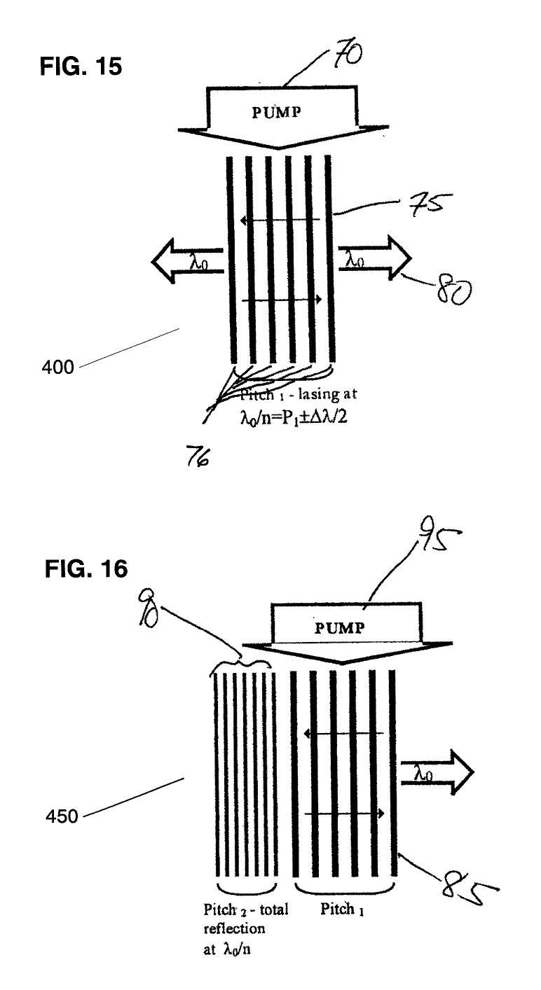

Referring now to FIG. 14, the emission spectrum of an amplifying medium (see FIGS. 15-20 below) is shown peaked near one of the stop-band edges. This phenomenon maximizes the efficiency of band-edge lasing. Similarly, laser power in a defect mode in the stop band is maximized when the peak in the emission spectrum is close to the frequency of the defect mode. It should be noted that the emission spectrum can also be peaked at the other band edge, or alternately at a defect state if one is present. Choosing a structure in which the emission peak overlaps specific mode peaks (i.e. low frequency edge, high frequency edge, defect) enables one skilled in the art to configure the parameters of the inventive laser as a matter of design choice.

FIGS. 15-20 show several embodiments of the inventive periodic laser. While the descriptions of the drawings refer to periodic layered structures, it should be understood that other materials having periodic properties such as cholesteric liquid crystals may also be utilized without departing from the spirit of the present invention.

Referring now to FIG. 15, a first embodiment of a stop band laser 400 of the present invention is shown, where the stop band laser is configured as an activated periodic structure of alternating layers 75 and 76. Because of the symmetry of this system radiation 80 of equal intensity emerges from both sides of the laser 400. The active material can be selected from, but is not limited to, a fluorescent dye, a conjugated polymer, and a rare earth element. An excitation source 70 is an optical pump or an electrical power source depending on the type of active material used in the structure 75, 76.

Referring now to FIG. 16, an alternate embodiment of the laser of FIG. 15 is shown as stop band laser 450, the difference being a juxtaposed layer 90 of different period from that of an active medium layer 85. If the frequency of laser radiation falls within the stop band of the added layer 90, it is strongly reflected. This results in lasing out of only one side of the device. An excitation source 95 is an optical pump or an electrical power source depending on the type of active material used in the active medium layer 85.

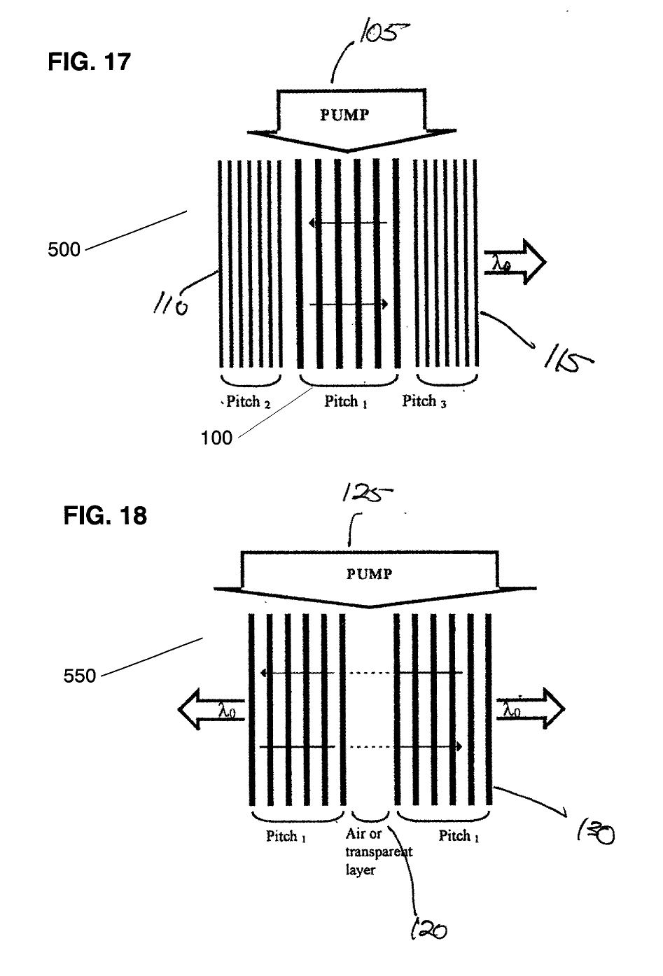

Referring now to FIG. 17, an alternate embodiment of the laser of FIG. 16 is shown as stop band laser 500. The stop band laser 500 includes a central active medium layer 100 and two additional juxtaposed layers 110 and 115 of a period different than the active medium layer 100. Adjustment of the period and thickness of layer 115 as a matter of design choice, can modify the effective reflectivity of this layer. This allows flexibility in the output coupling of the laser 500, which can be designed to maximize output power. An excitation source 105 is an optical pump or an electrical power source depending on the type of active material used in the active medium layer 100.

Referring now to FIG. 18, an alternate embodiment of the inventive stop band laser 550 includes a defect 120 in an active periodic structure 130. This produces a defect state with a frequency in the middle of the photonic stop band. Light emitted at the frequency of the defect state has a long residence time inside the medium. This enhances the effectiveness of stimulated emission at this frequency and leads to a high efficiency laser at this frequency when the emission spectrum is peaked thereon (see FIG. 14). An excitation source 125 is an optical pump or an electrical power source depending on the type of active material used in the active periodic structure 130.

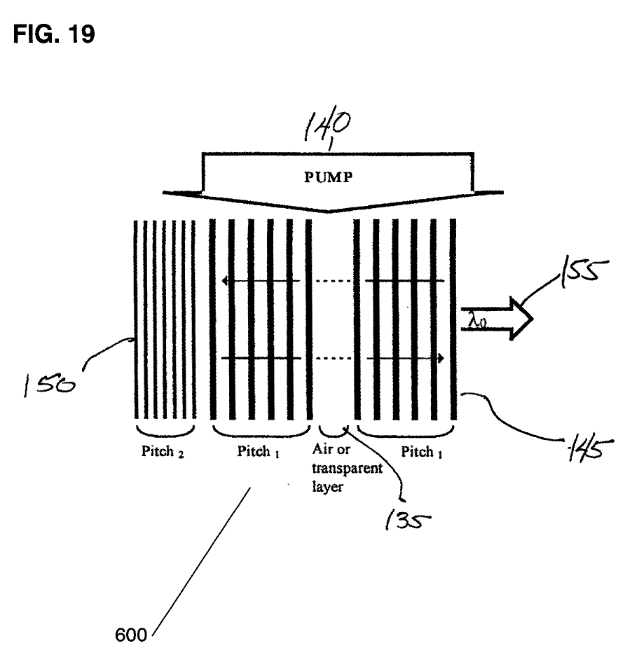

Referring now to FIG. 19, an alternate embodiment of the laser of FIG. 18 is shown as stop band laser 600. The stop band laser 600 includes a defect 135 in an active periodic structure 145 and is similar to the stop band laser 550, but with a juxtaposed layer 150 of a different period from that of the active periodic structure 145. If the frequency of laser radiation falls within the stop band of the added layer 145, it is strongly reflected. This results in lasing 155 out of only one side of the device. Lasing out of only one side of the device may equivalently be obtained if the defect 135 is not perfectly centered in the structure 145 so that a thicker layer of material is found on one side of the defect 135 (not shown). The laser radiation would emerge from the thinner side of the structure 145. An excitation source 140 is an optical pump or an electrical power source depending on the type of active material used in the active periodic structure 145.

Referring now to FIG. 20, an alternate embodiment of the laser of FIG. 19 is shown as stop band laser 650. The stop band laser 650 includes a defect 160 in an active periodic structure 165 and is similar to the stop band laser 600, but with two juxtaposed layers 175, 180 of a different period from that of the active periodic structure 165 and positioned on each side of the structure 165. Adjustment of the period and thickness of the layer 180 can modify the effective reflectivity of this layer and thus change the direction in which lasing occurs. An excitation source 170 is an optical pump or an electrical power source depending on the type of active material used in the active periodic structure 165.

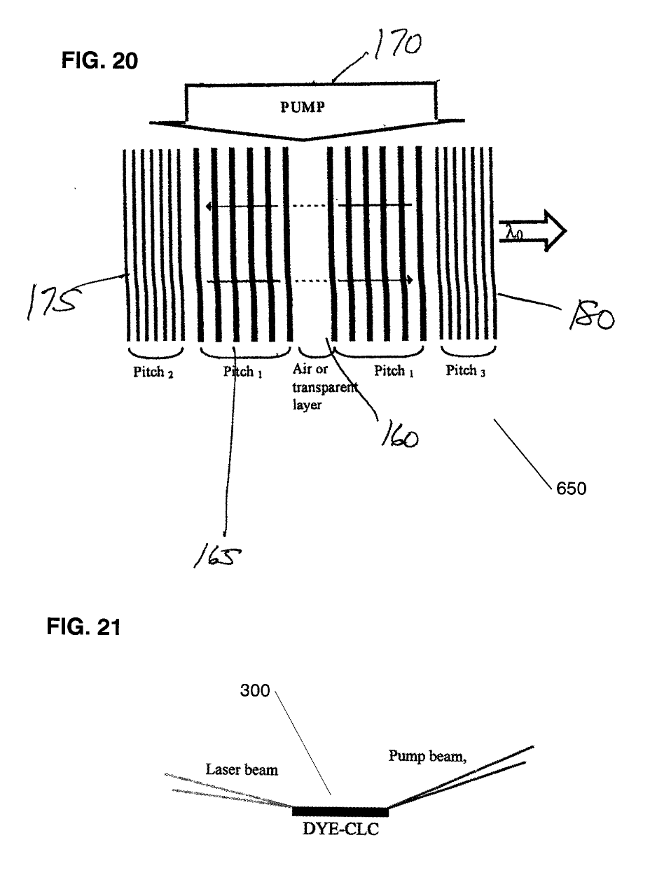

FIG. 21 shows a CLC laser excited by a line of exciting radiation in the plane of the sample. The long path along the line provides ample gain length to induce lasing in this sample. The lasing frequency is at the band edge. Such planar edge laser can be part of an integrated photonic device on the plane.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A laser apparatus comprising:
an active periodic one dimensional dielectric structure configured to produce a photonic stop band having at least one long-lived photonic mode occurring therein; and
excitation means, applied to said active periodic structure, for causing said active periodic structure to emit electromagnetic radiation, wherein said excitation means is configured to produce peak gain approximately positioned at one of said at least one long-lived photonic modes such that lasing output occurs with at least one of: a maximum output power and a minimized lasing threshold.

2. The laser apparatus of claim 1, wherein said at least one long lived photonic mode is located at least at one of: a first band edge of said photonic stop band, and a second band edge of said photonic stop band.

3. The laser apparatus of claim 1 further comprising a defect disposed in said structure causing a defect state therein, wherein said at least one long-lived photonic mode is located at least at on of: a first band edge of said photonic stop band, a second band edge of said photonic stop band, and a defect state substantially central to said photonic stop band.

4. The laser apparatus of claim 3, wherein said defect comprises one of: a spatial displacement between portions of said structure, and an additional material positioned within said structure.

5. The laser apparatus of claim 1, wherein said dielectric structure is a cholesteric liquid crystal.

6. The laser apparatus of claim 1, wherein said active periodic structure comprises at least one of: a fluorescent dye, a conjugated polymer, and a rare earth element.

7. A laser apparatus comprising:
an active periodic one dimensional dielectric structure configured to produce a photonic stop band having a first band edge and a second band edge; and
excitation means, applied to said active periodic structure, for causing said active periodic structure to emit electromagnetic radiation, wherein said excitation means is configured to produce peak gain positioned at approximately one of said first band edge and said second band edge such that lasing output occurs with at least one of: a maximum output power and a minimized lasing threshold.

8. A laser apparatus comprising:
an active periodic one dimensional dielectric structure having a defect disposed therein and configured to produce a photonic stop band having a first band edge, a second band edge and a defect state corresponding to said defect; and
excitation means, applied to said active periodic structure, for causing said active periodic structure to emit electromagnetic radiation, wherein said excitation means is configured to produce peak gain positioned at approximately one of said first band edge, said second band edge, and said defect state such that lasing output occurs with at least one of: a maximum output power and a minimized lasing threshold.

9. A laser comprising:
an active periodic one dimensional dielectric structure of a first periodicity, comprising an active element and configured to produce a photonic stop band having a first band edge and a second band edge; and
an excitation source applied to said periodic structure operable to cause lasing at the wavelength of one of said stop band edges in a direction perpendicular to said periodic structure.

10. The laser of claim 9, further comprising:
a second periodic structure of a second periodicity adjacent to said active periodic structure for reflection of said lasing.

11. The laser of claim 10, further comprising:
a third periodic structure of a third periodicity, said third periodic structure being optimized for at least maximum output lasing power, positioned adjacent to said active periodic structure.

12. The laser of claim 9, further comprising:
a defect within said active periodic structure to distort said first periodicity to create at least one additional photonic defect state within said stop band, such that lasing is produced at a frequency corresponding to the defect state.

13. The laser of claim 9, wherein said active element comprises at least one of: a fluorescent dye, a conjugated polymer, and a rare earth element.

14. The laser of claim 9, wherein said active periodic structure is a cholesteric liquid crystal.

15. The laser of claim 14, wherein said cholesteric liquid crystal comprises a first pitch, a first ordinary index of refraction, and a first extraordinary index of refraction, further comprising:
a second periodic structure having at least one of: a second pitch, a second ordinary index of refraction, and a second extraordinary index of refraction, said second periodic structure being positioned adjacent to said active periodic structure for reflection of lasing output.

16. The laser of claim 15, further comprising:
a third periodic structure having at least one of: a third pitch, a third ordinary index of refraction, and a third extraordinary index of refraction, said third periodic structure being positioned adjacent to said active periodic structure and opposite from said second periodic structure, said third periodic structure being optimized for at least one of: a maximum output power and a minimized lasing threshold.

17. The laser of claim 9, wherein said active periodic structure is a layered dielectric structure.

18. The laser of claim 17, wherein said layered dielectric structure comprises alternating layers of a dielectric materials having correspondingly alternating indices of refraction.

19. The laser of claim 18, wherein said layered dielectric structure comprises a first period, a first ordinary index of refraction, and a first extraordinary index of refraction, further comprising:
a second periodic structure having at least one of: a second period, a second ordinary index of refraction, and a second extraordinary index of refraction, said second periodic structure being positioned adjacent to said active periodic structure for reflection of lasing output.

20. The laser of claim 19, further comprising:
a third periodic structure having at least one of: a third period, a third ordinary index of refraction, and a third extraordinary index of refraction, said third periodic structure being positioned adjacent to said active periodic structure and opposite from said second periodic structure, said third periodic structure being optimized for at least one of: a maximum output power and a minimized lasing threshold.

21. A laser comprising:
an active cholesteric liquid crystal structure configured to produce a photonic stop band having a first band edge and a second band edge, and comprising an active material responsive to optical pumping; and
an optical pump applied to said cholesteric liquid crystal structure for causing lasing at one of said band edges.

22. A laser comprising:
an active cholesteric liquid crystal structure configured to produce a photonic stop band having a first band edge and a second band edge, and comprising an active material responsive to voltage applied thereto; and
a voltage source applied to said cholesteric liquid crystal structure for causing lasing at one of said band edges.

23. A laser comprising:
a planar active cholesteric liquid crystal structure configured to produce a photonic stop band having a first band edge and a second band edge, and comprising an active material; and
an excitation source applied to said active cholesteric liquid crystal structure in its plane for causing lasing at one of said band edges, said lasing being emitted in a plane of said cholesteric liquid crystal structure.

24. A method of lasing, comprising the steps of:
(a) providing an active periodic one dimensional dielectric structure configured to produce a photonic stop band having a plurality of long-lived photonic modes occurring therein;
(b) configuring an excitation source to produce peak gain approximately positioned at one of said plural long-lived photonic modes; and
(c) applying excitation to said active periodic structure via said excitation source to cause said active periodic structure to emit electromagnetic radiation with at least one of: a maximum output power and a minimized lasing threshold.

25. The method of lasing of claim 24, wherein said plural long lived photonic modes are located at least at one of: a first band edge of said photonic stop band and a second band edge of said photonic stop band.

26. The method of lasing of claim 24, further comprising the step of:
(d) prior to said step (b), generating an additional long lived photonic mode in said periodic structure by causing a defect in said structure.

27. The method of lasing of claim 26, wherein said defect comprises one of: a spatial displacement between portions of said structure and an additional material positioned within said structure.

28. The method of lasing of claim 24, wherein said dielectric structure is a cholesteric liquid crystal.

29. The method of lasing of claim 26, wherein said active periodic structure comprises at least one of: a fluorescent dye, a conjugated polymer, and a rare earth element.

30. A method of lasing comprising the steps of:
(a) providing an active periodic one dimensional dielectric structure configured to produce a photonic stop band having a first band edge and a second band edge;
(b) configuring an excitation source to produce peak gain positioned at approximately one of said first band edge and said second band edge; and
(c) applying excitation to said active periodic structure via said excitation source to cause said active periodic structure to emit electromagnetic radiation with at least one of: a maximum output power and a minimized lasing threshold.

31. A method of lasing, comprising the steps of:
(a) providing an active periodic one dimensional dielectric structure having a defect disposed therein and configured to produce a photonic stop band having a first band edge, a second band edge and a defect state corresponding to said defect;
(b) configuring an excitation source to produce peak gain positioned at approximately one of said first band edge, said second band edge, and said defect state; and
(c) applying excitation to said active periodic structure via said excitation source to cause said active periodic structure to emit electromagnetic radiation with at least one of: a maximum output power and a minimized lasing threshold.

32. A method of lasing, comprising the steps of:
(a) providing an active periodic one dimensional dielectric structure of a first periodicity, comprising an active element and configured to produce a photonic stop band having a first band edge and a second band edge; and
(b) applying excitation to said periodic structure to cause lasing at the wavelength of one of said stop band edges in a direction perpendicular to said periodic structure.

33. The method of claim 32, further comprising the step of:
(c) providing and positioning a second periodic structure of a second periodicity adjacent to said active periodic structure for reflection of said lasing.

34. The method of claim 33, further comprising the step of:
(d) providing and positioning, adjacent to said active periodic structure, a third periodic structure of a third periodicity, said third periodic structure being optimized for at least one of: a maximum output lasing power and a minimized lasing threshold.

35. A method of lasing, comprising the steps of:
(e) providing an active periodic one dimensional dielectric structure of a first periodicity and configured to produce a photonic stop band;
(f) providing a defect within said active periodic structure to distort said first periodicity to create at least one photonic defect state within said stop band; and
(g) applying excitation to said periodic structure to cause lasing at the wavelength of said defect state in a direction perpendicular to said periodic structure.

36. The method of claim 32, wherein said active element comprises at least one of: a fluorescent dye, a conjugated polymer, and a rare earth element.

37. The method of claim 32, wherein said active periodic structure is a cholesteric liquid crystal.

38. The method of claim 37, wherein said cholesteric liquid crystal comprises a first pitch, a first upper index of refraction, and a first extraordinary index of refraction, further comprising the step of:
(h) providing, and positioning adjacent to said active periodic structure, a second periodic structure having at least one of: a second pitch, a second upper index of refraction, and a second extraordinary index of refraction, to cause reflection of lasing output.

39. The method of claim 38, further comprising the step of:
(i) providing, and positioning adjacent to said active periodic structure and opposite from said second periodic structure, a third periodic structure having at least one of: a third pitch, a third upper index of refraction, and a third extraordinary index of refraction, said third periodic structure being optimized for at least one of: a maximum output lasing power and a minimized lasing threshold.

40. The method of claim 32, wherein said active periodic structure is a layered dielectric structure.

41. The method of claim 40, wherein said layered dielectric structure comprises alternating layers of a dielectric materials having correspondingly alternating upper and lower indices of refraction.

42. The method of claim 41, wherein said layered dielectric structure comprises a first period, a first upper index of refraction, and a first lower index of refraction, further comprising the step of:
(j) providing, and positioning adjacent to said active periodic structure, a second periodic structure having at least one of: a second period, a second upper index of refraction, and a second lower index of refraction, to cause reflection of lasing output.

43. The method of claim 42, further comprising the step of:
(k) providing, and positioning adjacent to said active periodic structure and opposite from said second periodic structure, a third periodic structure having at least one of: a third period, a third upper index of refraction, and a third lower index of refraction, said third periodic structure being optimized for at least one of: a maximum output lasing power and a minimized lasing threshold.

44. A method of lasing comprising the steps of:
(a) providing an active cholesteric liquid crystal structure configured to produce a photonic stop band having a first band edge and a second band edge, and comprising an active material responsive to optical pumping; and
(b) applying an optical pump to said cholesteric liquid crystal structure to cause lasing at one of said band edges.

45. A laser comprising:
(a) providing an active cholesteric liquid crystal structure configured to produce a photonic stop band having a first band edge and a second band edge, and comprising an active material responsive to voltage applied thereto; and
(b) applying a voltage source to said cholesteric liquid crystal structure to cause lasing at one of said band edges.

46. A method of lasing comprising the steps of:
(a) providing a planar cholesteric liquid crystal structure configured to produce a photonic stop band having a first band edge and a second band edge, and comprising an active material; and
(b) applying an excitation source to said cholesteric liquid crystal structure in its plane to cause lasing at one of said band edges, said lasing being emitted in a plane of said cholesteric liquid crystal structure.
